(19) United States
(12) Patent Application Publication
(10) Pub. No.: US 2009/0238574 A1
(43) Pub. Date: Sep. 24, 2009

(54) APPARATUS AND METHOD FOR MONITORING OPTICAL GATE DEVICE, AND OPTICAL SWITCH SYSTEM

(75) Inventor: Kyosuke SONE, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/401,928

(22) Filed: Mar. 11, 2009

(30) Foreign Application Priority Data
Mar. 18, 2008 (JP) 2008-069102

(51) Int. Cl. H04B 10/00

(52) U.S. Cl. 398/139

(57) ABSTRACT

An optical gate device transmits or interrupts input light according to control information. The optical gate device includes a light-receiver that obtains input and output optical powers of the optical gate device, and a monitor that obtains optical input and output characteristics of the optical gate device based on the control information and the monitored input and output optical powers, the optical input and output characteristics being equivalent to a time the optical gate device is controlled in a transmitted state.

### CROSS-REFERENCE TO RELATED APPLICATIONS

This application is based upon and claims the benefit of priority of the prior Japanese Patent Application No. 2008-069102, filed on Mar. 18, 2008, the entire contents of which are incorporated herein by reference.

### BACKGROUND

1. Field

The embodiments discussed herein are related to an optical gate device and an optical switch system. For example, sometimes the disclosure is applied to an apparatus that switches a path of light using an optical gate device such as a semiconductor optical amplifier (SOA) in an optical communication system.

2. Description of the Related Art

Conventionally, for example, there is known a method for monitoring and controlling an optical repeater of an optical fiber relay transfer system in which signal light propagating through an optical fiber is amplified and relayed by the optical repeater while remaining light. In the monitoring and controlling method, a sine-wave signal having a frequency lower than a signal bit-rate frequency is superimposed on signal light by intensity modulation, thereby forming a control signal. Part of the amplified light in the optical repeater is branched, and an amplification degree of the optical repeater is controlled such that a control signal level of the branched light is kept constant (for example, see Japanese Patent Publication No. 07-120980).

In the conventional monitoring and controlling method, a gain of the semiconductor optical amplifier can be kept constant with respect to a change in temperature of the optical repeater and a change in polarization state of an optical fiber. Further, an operating state and switching of the semiconductor optical amplifier can be controlled remotely and monitored.

### SUMMARY

According to an aspect of the invention, an optical gate device which transmits or interrupts input light according to control information includes a light-receiver that obtains input and output optical powers of the optical gate device; and a monitor that obtains optical input and output characteristics of the optical gate device based on the control information and the monitored input and output optical powers, the optical input and output characteristics being equivalent to a time the optical gate device is controlled in a transmitted state.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

The above-described embodiments of the present invention are intended as examples, and all embodiments of the present invention are not limited to including the features described above.

### BRIEF DESCRIPTION OF THE DRAWINGS

FIG. 1 illustrates an example of an optical packet switch system in which an SOA is used;

FIG. 2 illustrates an example of a current-optical gain characteristic of the SOA;

FIG. 3 illustrates a block diagram of an example of an optical gain monitoring configuration of the SOA;

FIG. 4 illustrates a block diagram of an example of a redundant configuration of the SOA;

FIG. 5 schematically illustrates input and output examples in switching control of the SOA;

FIG. 6 illustrates a block diagram of an example of an optical gain monitoring configuration of the SOA;

FIG. 7 illustrates a block diagram of a configuration example of an optical packet switch system according to a first embodiment having an optical gain monitoring function;

FIG. 8 schematically illustrates input and output examples of the SOA in the optical packet switch system of FIG. 7;

FIG. 9 illustrates an optical gain monitoring method of the optical packet switch system of FIG. 7;

FIG. 10 illustrates a block diagram of a configuration example of an optical interconnect system according to a second embodiment; and

FIG. 11 illustrates a block diagram of a configuration example of an Optical Add-Drop Multiplexer (OADM) according to a third embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

An exemplary embodiment of the invention will be described below with reference to the drawings. However, the following embodiments are described only by way of example, and application of various modifications and techniques is not excluded. That is, various modifications (such as a combination of embodiments) can be made without departing from the scope of the embodiments.

### [1] Exemplary Embodiment

An optical packet switching technology can be cited as an example of a technology that has the potential to enable a flexible broadband network configuration in the future. In optical packet switching, packet exchange is performed while information remains light. High-speed and large-capacity transfer can be realized compared with the case in which the switching is performed after the light signal is converted into the electric signal.

A gate switch (optical gate device) may be used to transmit or interrupt (turn on/off) the light signal when the light signal is switched in units of packets. Examples of the optical gate device that turns the light signal on and off by electric control includes a device in which light interference based on an electro-optic effect is utilized, a device in which an electro-absorption effect is utilized, and a device in which SOA being able to change a gain by a driving current is utilized.

A SOA functions not only as an optical gate switch turning the light signal on and off but also an amplifier. Therefore, a SOA attracts attention as an optical device that performs high-speed switching while compensating for a loss of light signal. A SOA has a high extinction ratio in turning the light signal on and off, so that a code error ratio can be decreased. Further, because a SOA is an optical device made of a semiconductor material, cost reduction and miniaturization can be achieved advantageously by a semiconductor integration technology.

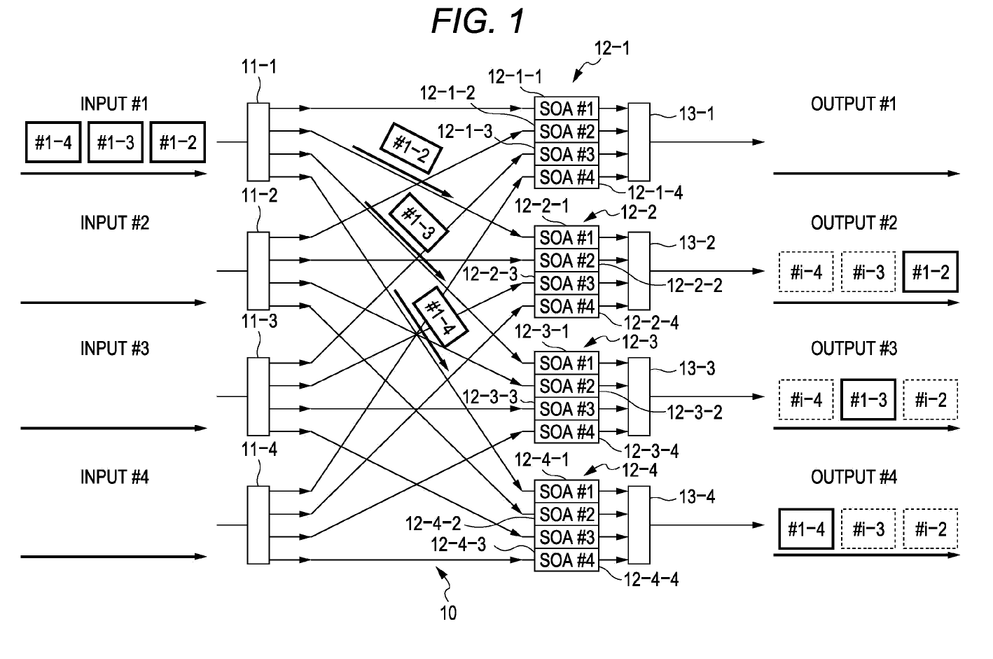

FIG. 1 illustrates an example of a broadcast-and-select optical packet switch system in which a SOA is used as the optical gate switch. The system illustrated in FIG. 1 includes a 4-by-4 optical switch unit 10 having four input ports #1 to #4 and four output ports #1 to #4.

The optical switch unit 10 includes optical couplers (1:4 branch couplers) 11-1 to 11-4 corresponding to the input ports #1 to #4, optical couplers (4:1 merge couplers) 13-1 to 13-4 corresponding to the output ports #1 to #4, and SOA integrated circuits 12-1 to 12-4 each of which is provided at the input port #i (output port #i).

The SOA integrated circuit 12-i includes the number of SOAs 12-i-1 to 12-i-4 (#1 to #4) (for example, four SOAs in FIG. 1) corresponding to the number of output ports of the branch coupler 11-i (the number of input ports of the merge coupler 13-i). The four output ports of the branch couplers 11-i are collected into the SOA integrated circuit 12-i, and each output port of the branch coupler 11-i is connected to an SOA 12-i-j (j=1 to 4).

The signal light fed into the input port #i is branched (power-branched) into the number of output ports #i by the corresponding branch coupler 11-i (hereinafter simply referred to as “branch coupler 11”), that is, the same signal light is supplied to four ports. The branched signal light is fed into the SOA 12-i-j.

The SOA 12-i-j (hereinafter sometimes simply referred to as “SOA 12”) is turned on when the signal light that should be supplied to the output port #i is transmitted). The SOA 12-i-j is subject to switching (gating) control to be turned off in other conditions. A controller that performs the switching control is omitted in FIG. 1.

The components of signal light (optical packet signal) transmitted through the SOA 12-i-j are merged by the merge coupler 13-i (hereinafter sometimes simply referred to as “merge coupler 13”) and supplied to the output port #i. Thus, the signal light (optical packet) fed into one of the input ports #i can be supplied (switched) to one of the output ports #1.

It is assumed that #i-t is an optical packet fed into the input port #i at a time t (t=1, 2, 3, . . . ). FIG. 1 illustrates the state in which, in the optical packets #1-2, #1-3, and #1-4 fed into the input port #1, the optical packet #1-2 is supplied to the output port #2, the optical packet #1-3 is supplied to the output port #3, and the optical packet #1-4 is supplied to the output port #4.

Although the configuration of the 4-by-4 optical packet switch system is illustrated in FIG. 1, the 4-by-4 optical packet switch system is easily generalized in an m-by-n (including m=n) optical packet switch system. That is, m 1:m branch couplers 11 corresponding to m input ports #1 to #m, m-by-n SOAs 12, and n n:1 merge couplers 13 corresponding to n output ports #1 to #n may be provided.

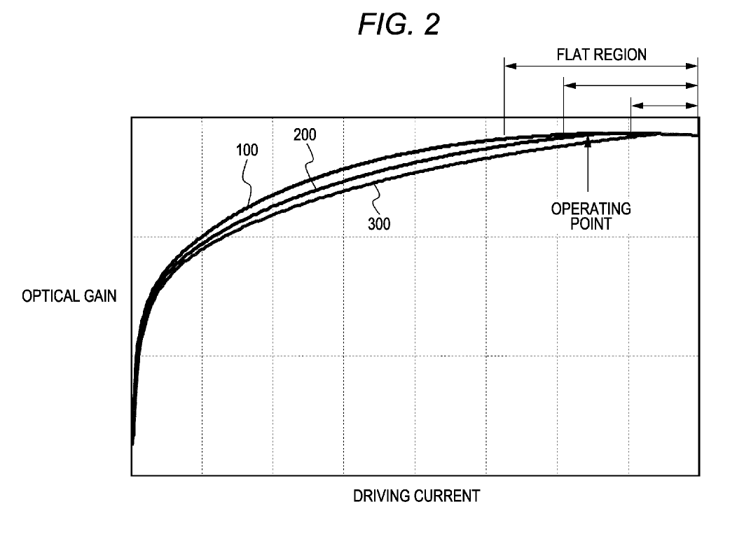

Sometimes the optical gain deteriorates when the SOA 12 is operated (driven) for a long time. FIG. 2 illustrates an example of a driving current-optical gain characteristic of a SOA.

In an embodiment, the SOA 12 is preferably operated in a flat region where the gain is substantially kept constant with respect to a change in current. However, when the SOA 12 is operated for a long time, the gain characteristic deteriorates (see numerals 100, 200, and 300). When the gain characteristic deteriorates, a value of the driving current at which the flat region is started is shifted toward a direction in which the driving current is increased, and the flat region is narrowed. When the phenomenon is generated, the deterioration of the gain characteristic of the SOA 12 becomes easily advanced. Because of the needs for the larger driving current, a setting of an operating point of the SOA 12 at the shifted flat region is unfavorable from the viewpoint of power consumption.

Accordingly, when the phenomenon is detected during the operation of the SOA 12, a countermeasure such as the switching to a backup SOA 12 can be taken in an early stage. Monitoring the optical gain of the SOA 12 can be cited as an example of a technique of detecting the phenomenon.

The optical gain of the SOA 12 is substantially kept constant when the operating point of the SOA 12 exists in the flat region. However, the optical gain is lowered, when the value of the driving current deviates from the flat region while the flat region is shifted. Therefore, the phenomenon that is a precursor of the characteristic deterioration may be detected by monitoring the optical gain of the SOA 12.

If the SOA 12 is used as an optical amplifier instead of as an optical gate switch, components monitoring a ratio of input and output powers of the SOA 12 may compute the optical gain from a monitoring value of the ratio because all the components of input light are amplified by and supplied from the SOA 12.

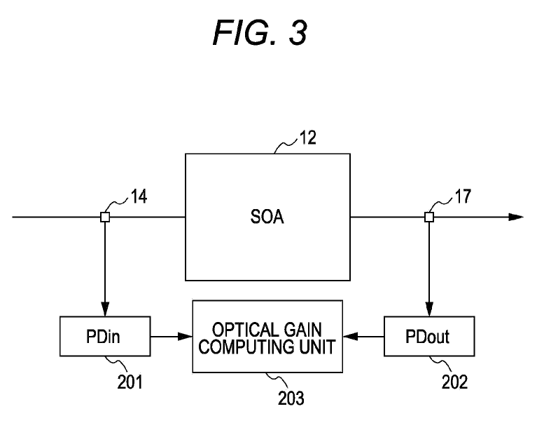

As illustrated in FIG. 3, input light and output light of the SOA 12 are partially branched by optical couplers 14 and 17 components. Components of the branched light are received by optical receivers 201 and 202 such as Photo Diode (PD). The optical gain computer 203 determines the optical gain of the SOA 12 based on current values corresponding to optical powers received by the optical receivers 201 and 202.

Assuming that PDin [dBm] is an input optical power level (current value) monitored by the optical receiver 201 on the input side of the SOA 12 while PDout [dBm] is an optical output power level (current value) received by the optical receiver 202 on the output side, the optical gain computer 203 obtains the optical gain [dB] of the SOA 12 from the following equation (1):

Optical gain [dB]=PDout−PDin (1)

The optical gain of the SOA 12 is stored upon initialization, and the optical gain is periodically computed and compared with the initial setting. When a deterioration amount of the optical gain of the SOA 12 exceeds a given value, for example, an alarm is issued or the SOA 12 is switched to the backup SOA 12. The deterioration amount [dB] of the optical gain is obtained by subtracting the current optical gain [dB] from the initial optical gain [dB].

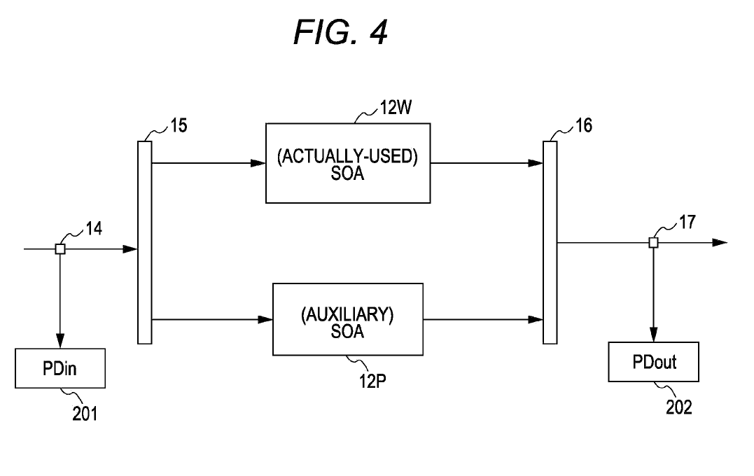

FIG. 4 illustrates an example of a redundant configuration of the SOA 12. In the redundant configuration of FIG. 4, working and backup SOAs 12w and 12p are prepared, an optical (branch) coupler 15 is disposed on the input side, and an optical (merge) coupler 16 is disposed on the output side. The optical receiver 201 is disposed on the input side of the branch coupler 15, and the optical receiver 202 is disposed on the output side of the merge coupler 16, whereby optical receivers 201 and 202 are shared by the working SOA 12w and the backup SOA 12p.

When the redundant configuration of FIG. 4 is utilized, the operation can be continued by switching the working SOA 12w to the backup SOA 12p even if a trouble is generated such that the deterioration amount of the gain of the working SOA 12w exceeds an allowable range. The SOA 12w in which the trouble is generated may be exchanged without interrupting the operation.

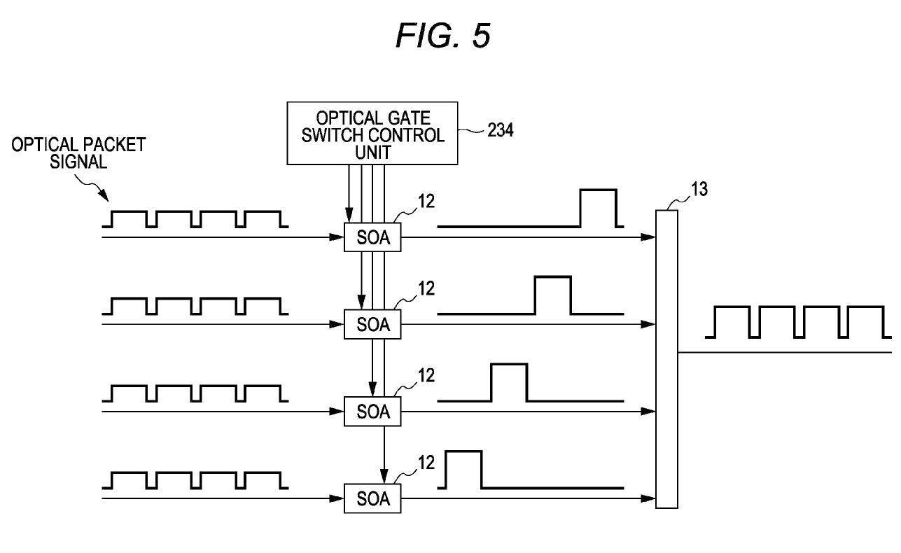

Thus, the deterioration amount of the gain of the SOA 12 may be monitored when the SOA is used as the amplifier. On the other hand, when the SOA 12 is used as the optical gate switch, sometimes the optical gain is incorrectly obtained by the above-described monitoring technique. An example will be described with reference to FIG. 5.

FIG. 5 illustrates the state in which the optical packet signals are fed into four SOAs. The signal light that should be transmitted is selectively supplied from each SOA 12 under the control of an optical gate switch controller 234, and other components of signal light are interrupted by the SOA 12. The signal light is sparsely (intermittently) supplied from each SOA 12.

Therefore, even if the output signal light power of the SOA 12 is simply monitored by the optical receiver such as PD, the optical output power level is incorrectly obtained and the optical gain is incorrectly computed. The optical output power level is correctly obtained when the optical output power level is monitored only in the time the SOA 12 is turned on (that is, in each optical packet signal). However, because the SOA 12 is switched at as fast as hundreds of nanoseconds, clear pulse intensity is hardly recognized even if the signal light (optical packet signal) is monitored.

Therefore, total input and output optical powers in a certain level of period during which plural optical packet signals are supplied are measured in the embodiment.

For example, when the optical packet signals are evenly inserted in input time slots to the SOA 12, the input light power level is obtained from an average power of a certain period (measurement period). Accordingly, when a ratio in which the SOA 12 is turned on to supply the optical packet signal is recognized in the measurement period, the optical output power level for the actually supplied optical packet signal may be obtained from the total optical output power of the SOA 12. That is, the optical gain of the SOA 12 is obtained from the equation (1).

Information on the number of optical packet signals supplied in the measurement period from the SOA 12 is obtained from a time the SOA 12 is turned on, that is, a time the gate is opened. Accordingly, the information may be obtained from information (hereinafter also referred to as switch control information) on the switching control of the optical gate switch controller 234 that performs the switching control of the SOA 12.

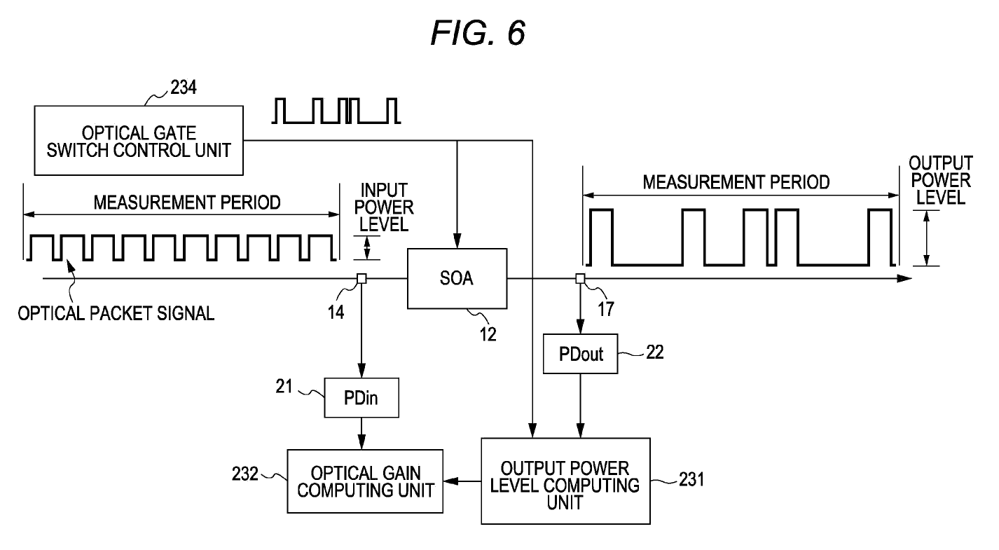

FIG. 6 illustrates an example of a configuration for monitoring the gain of the SOA 12. Referring to FIG. 6, optical receivers 21 and 22, an optical output power level computer 231, and an optical gain computer 232 are used as the monitoring apparatus that monitors the optical gain characteristic (optical input and output characteristic) of the SOA 12.

The SOA 12 is subject to the switching control of the optical gate switch controller 234. The optical coupler 14 is provided on the input side of the SOA 12, and the input signal light (optical packet signal) is partially branched into PD that is an example of the optical receiver 21. The optical coupler 17 is provided on the output side of the SOA 12, and the output signal light of the SOA 12 is partially branched into PD that is an example of the optical receiver 22.

The PD 21 produces a current according to the branched light power of the input signal light of the SOA 12, which is received from the optical coupler 14, and the PD 21 supplies the current as a monitoring value (measured value) of the input optical power of the SOA 12 to the optical gain computer 232. Similarly the PD 22 produces a current according to the branched light power of the output signal light of the SOA 12, which is received from the optical coupler 17, and PD 21 supplies the current as a monitoring value (measured value) of the output optical power of the SOA 12 to the optical output power level computer 231.

The optical output power level computer 231 obtains the optical output power level corresponding to a time the SOA 12 is turned on in a certain measurement period to actually supply the optical packet signal, based on the switch control information on the optical gate switch controller 234 and the optical output power monitoring value from the PD 22. That is, the optical output power level computer 231 computes the optical output power level from the following equation (2):

optical output power level [dBm]=average output optical power [dBm]×The number of time slots in the measurement period/the number of optical packets transmitted through the SOA (2)

The average output optical power may be obtained as the monitoring value of the PD 22, and the number of optical packets transmitted through the SOA 12 in the measurement period may be obtained from the switching control information. The number of time slots in the measurement period may previously be retained as a well-known value in the system.

That is, the optical output power level computer 231 computes the optical output power level of the SOA 12 based on a ratio of a time the SOA 12 is controlled in the transmitted state in a certain measurement period and the output optical power of the SOA 12 in the measurement period. The optical output power level of the SOA 12 is equivalent to the time the SOA 12 is controlled in the transmitted state in the measurement period. The ratio is obtained based on the switch control information on the optical gate switch controller 234.

The obtained optical output power level is given to the optical gain computer 232, and the optical gain computer (optical input and output characteristic computer) 232 correctly obtains the optical gain from the equation (1) based on the optical output power level and the input optical power level monitored in the measurement period by the PD 21. The optical gain obtained by the optical gain computer 232 is independent of the turn-on/off of the SOA 12.

In FIG. 6, the optical output power level computer 231 and the optical gain computer 232 are used as an example of the monitor. The monitor obtains the optical gain (optical input and output characteristic) of the SOA 12 based on the switch control information on the optical gate switch controller 234 and the input and output optical powers of the SOA 12 which are obtained by the optical receivers 21 and 22. The optical gain of the SOA 12 is equivalent to the time the SOA 12 is controlled in the transmitted state.

The optical gain is computed in periodic timing, and the computed optical gain is compared with the initial optical gain. Therefore, when the deterioration amount of the optical gain exceeds the allowable range, the countermeasure can be taken such that an alarm is issued or such that the working SOA 12w is switched to the backup SOA 12p.

A PD that converts the signal light having a bit rate of 10 Gbit/s or more into an electric signal may possibly appear in the future. In such cases, the input and output optical power levels corresponding to the time the SOA 12 is turned on are accurately monitored (measured), so that the need for the conversion of the equation (2) may be eliminated.

### [2] First Embodiment

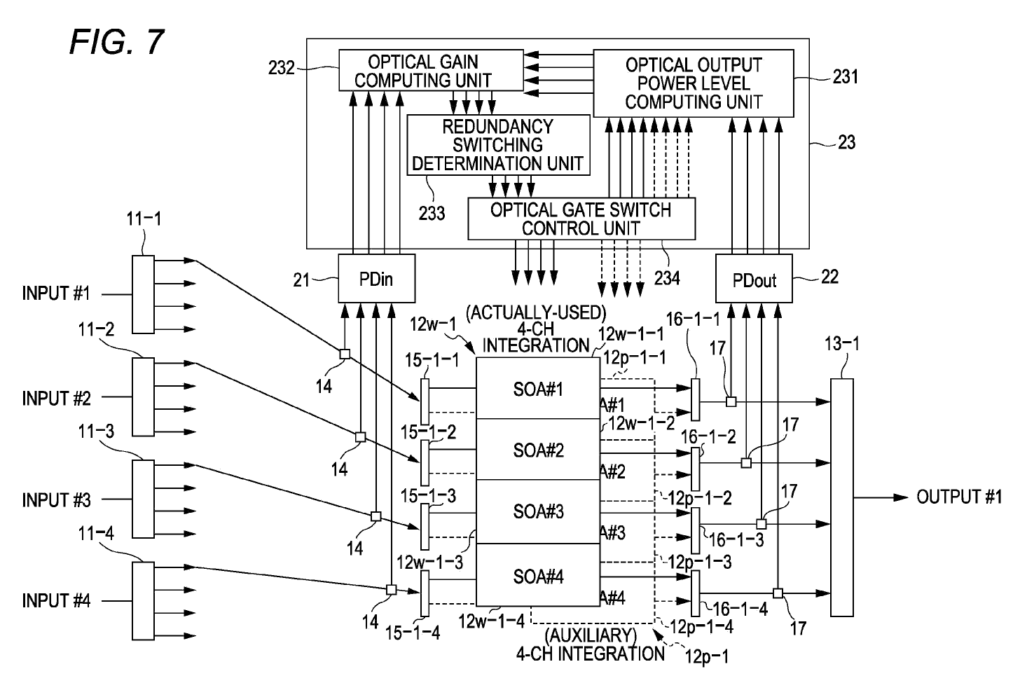

FIG. 7 illustrates a configuration example of an optical packet switch system according to a first embodiment in which redundancy of the SOA 12 is achieved to enable the switching to the backup SOA 12.

Similarly to the system of FIG. 1, the optical packet switch system of FIG. 7 is the 4-by-4 optical packet switch system having the four input ports #1 to #4 and the four output ports #1 to #4.

Therefore, similarly to the system of FIG. 1, the optical packet switch system includes the optical (branch) couplers 11-1 to 11-4 corresponding to the input ports #1 to #4, the optical (merge) couplers 13-1 to 13-4 corresponding to the output ports #1 to #4, working SOA integrated circuits 12w-1 to 12w-4, and backup SOA integrated circuits 12p-1 to 12p-4. The working SOA integrated circuits 12w-1 to 12w-4 and the backup SOA integrated circuits 12p-1 to 12p-4 are provided in each input port #i (output port #i). However, FIG. 7 illustrates the configuration focusing on one set of sets of four SOA integrated circuits 12w-i (SOA integrated circuit 12p-i) and branch couplers 13-i, for example, a set of the SOA integrated circuit 12w-1 (12-p) and branch coupler 13-1.

Four (4-channel) SOAs (#1 to #4) 12w-i-1 to 12w-i-4 are integrated in a working SOA integrated circuit 12w-i, and four (4-channel) SOAs (#1 to #4) 12p-i-1 to 12p-i-4 are integrated in a backup SOA integrated circuit 12w-i. Hereinafter sometimes the four SOAs 12w-i-1 to 12w-i-4 and four SOAs 12p-i-1 to 12p-i-4 are referred to as the SOA 12w and the SOA 12p, respectively, when the SOAs 12w-i-1 to 12w-i-4 and the SOAs 12p-i-1 to 12p-i-4 are not distinguished from one another. Sometimes the suffixes w and p are omitted when the working SOA 12w and the backup SOA 12p are not distinguished from each other.

As illustrated in FIG. 4, in the set of working SOA 12w-1-j and the backup SOA 12p-1-j, the input is connected to the optical coupler (1:2 branch coupler) 15-1-j and the output is connected to the optical coupler (2:1 merge coupler) 16-1-j, whereby the working SOA 12w and the backup SOA 12p may be switched.

In operating the working SOA 12w, the backup SOA 12p is turned off, and the output light of the working SOA 12w is supplied from the merge coupler 16-1-j. When the working SOA 12w is switched to the backup SOA 12p, the backup SOA 12p is set at the operation state, and the working SOA 12w is turned off, whereby the output light of the backup SOA 12p is supplied from the merge coupler 16-1-j.

Each of the input ports of the branch coupler 15-1-j is connected to one of four output ports of the branch coupler 11-i, and each of the output ports of the merge coupler 16-1-j is connected to the input port of the merge coupler 13-1.

The branch coupler 14 is provided in the middle of the optical path from the branch coupler 11-i to the branch coupler 15-1-j in order to take out part of the light fed into the SOA 12. The part of the light fed into the SOA 12, which is branched by the branch coupler 14, is fed into the optical receiver 21.

The branch coupler 17 is provided in the middle of the optical path from the merge coupler 16-1-j to the merge coupler 13-1 in order to take out part of the light supplied from the SOA 12. The part of the light supplied from the SOA 12, which is branched by the branch coupler 17, is fed into the optical receiver 22.

For example, each of the optical receivers 21 and 22 is an integrated PD in which PDs (four PDs in the first embodiment) corresponding to the number of branch couplers 14 or the number of branch couplers 17 are integrated. Each of the optical receivers 21 and 22 separately produces the current value according to the power of the branched light and supplies the current value as the monitoring value of the light power. Alternatively, PDs that are not integrated may be provided according to the branch couplers 14 and the branch couplers 17.

The optical receiver 21 may receive part of the light fed into the branch coupler 11-i (that is, before the light branched by the coupler 11-i). In such cases, based on a branch ratio of the branch coupler 11-i and an insertion loss, the optical gain computer 232 corrects (converts) the monitoring value of the input optical power into a value equivalent to the monitoring value of the input optical power of the light branched by the branch coupler 11-i. The components of information on the branch ratio and the insertion loss may previously be retained in the optical gain monitoring controller 23.

As described above with reference to FIG. 6, it is not always necessary that the monitoring value be an instantaneous value when the input and output optical powers are monitored to obtain the optical gain of the SOA 12. That is, because the monitoring value is obtained as an average value in a certain period, an inexpensive PD having a relatively low response speed may be used as PD for the optical receivers 21 and 22. An expensive PD that converts the signal light having the high bit rate (for example, several gigabits per second) into the electric signal may be used if possible from the viewpoint of cost.

The outputs of the optical receivers 21 and 22 are connected to the optical gain monitoring controller 23. The optical gain monitoring controller 23 has both the optical gain monitoring function of the SOA 12 and the switching control function. Alternatively, the functions may be provided as individual functional unit. The optical gain monitoring controller 23 includes the optical output power level computer 231, the optical gain computer 232, the redundancy switching determination unit 233, the optical gate switch controller 234.

The optical gate switch controller 234 produces a gate control signal to control SOAs #1 to #4. The gate control signal is used to control the gains of the SOAs #1 to #4. That is, in the SOAs #1 to #4, the turn-on/off state is controlled in response to the gate control signal.

As described above with reference to FIG. 6, the optical output power level computer 231 computes the optical output power levels of the SOAs #1 to #4 using the equation (2) based on the monitoring values of the output optical powers of the SOAs #1 to #4 supplied from the optical receiver 22 and the switching control information on the optical gate switch controller 234.

The optical gain computer 232 obtains the optical gains of the SOAs #1 to #4 based on the monitoring value of the input optical powers of the SOAs #1 to #4 supplied from the optical receiver 21 and the optical output power levels of the SOAs #1 to #4 computed by the optical output power level computer 231.

The redundancy switching determination unit 233 compares the optical gains of the SOAs #1 to #4 obtained by the optical gain computer 232 with a predetermined threshold in periodic timing, and determines whether or not the deterioration amount of the optical gain falls within the allowable range in each of the SOAs #1 to #4. When the optical gain obtained by the optical gain computer 232 exceeds the predetermined threshold, the redundancy switching determination unit 233 determines that the deterioration amount of the optical gain falls within the allowable range. When the optical gain obtained by the optical gain computer 232 does not exceed the predetermined threshold, the redundancy switching determination unit 233 determines that the deterioration amount of the optical gain is out of the allowable range.

When determining that the deterioration amount of the optical gain is out of the allowable range for all the SOAs #1 to #4, the redundancy switching determination unit 233 notifies the optical gate switch controller 234 that the deterioration amount of the optical gain is out of the allowable range for all the SOAs #1 to #4, and the optical gate switch controller 234 switches the working SOA 12w to the backup SOA 12p. At this point, only the SOA #i whose deterioration amount of the optical gain is out of the allowable range may be switched to the backup SOA #i, or all the SOAs #1 to #4 may be switched to the backup SOAs #1 to #4.

The former case has an advantage in a cost phase because only the deteriorated SOA is switched to the backup SOA. In the latter case, reliability is improved by switching all the SOAs to the backup SOAs, because the optical gains are possibly deteriorated in other SOAs when the optical gain deteriorates in one of the SOAs.

The redundancy switching determination unit 233 acts as an example of the optical gate device switching controller that switches the working SOA 12 to the backup SOA 12 when the optical gain obtained by the optical gain computer 232 deteriorates more than the predetermined threshold.

After the working SOA #i is switched to the backup SOA #, the optical gain monitoring controller 23 may monitor the optical gains of the SOAs #i.

The function of the redundancy switching determination unit 233 may be included in the optical gain computer 232 or the optical gate switch controller 234. Instead of or in addition to the redundancy switching determination unit 233, when the determination that the deterioration amount of the optical gain is out of the allowable range is made by the threshold determination, the alarm may be generated to exhibit the determination on an operator terminal.

(Example of Operation)

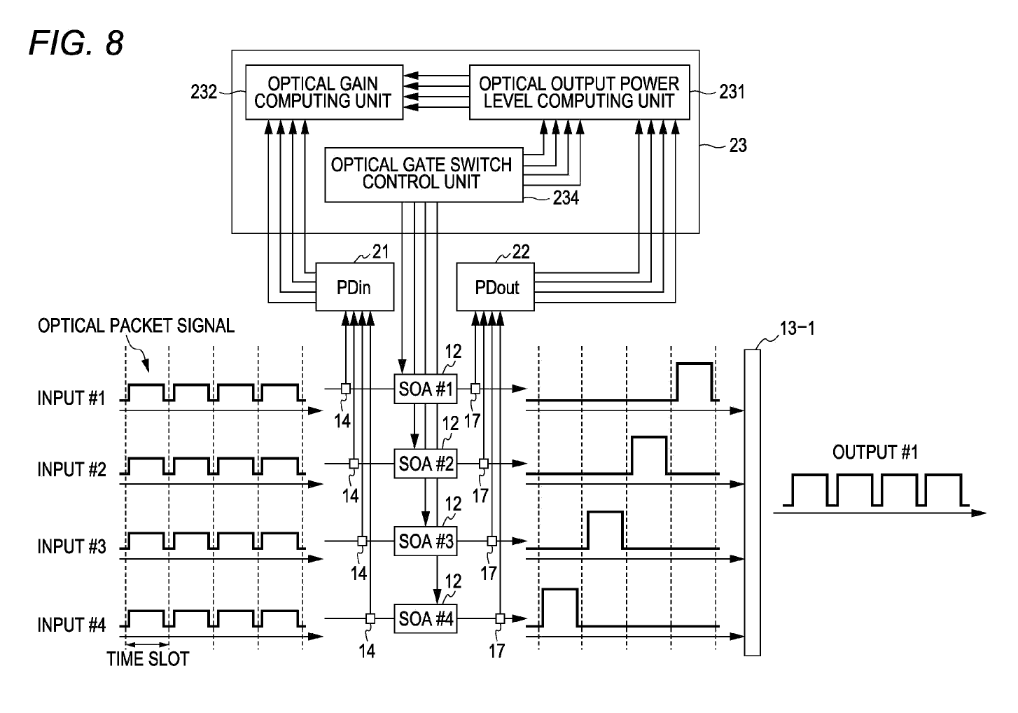

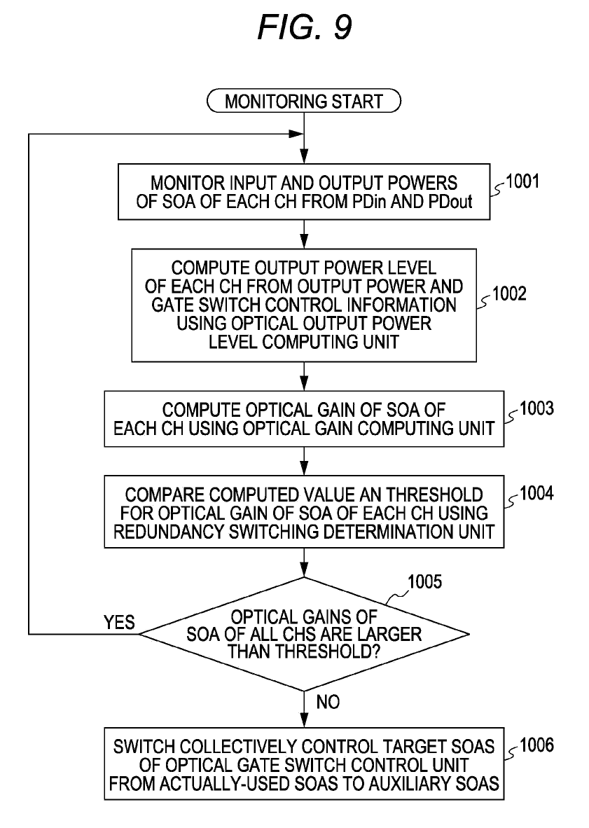

An example of the operation of the optical packet switch system will be described below with reference to FIGS. 8 and 9.

The components of signal light (optical packet signals) are sent to the input ports #1 to #4. Each optical packet signal is branched by the corresponding branch coupler 11-i and introduced to one of the SOAs #1 to #4. Part of the input signal light is branched on the way by the branch coupler 14 and fed into the optical receiver 21.

As illustrated in FIG. 8, it is assumed that the components of signal light (optical packet signals) reach the inputs of the SOAs #1 to #4 from the input ports #1 to #4. In an embodiment, the signal light powers fed into the SOAs #1 to #4 are substantially kept constant.

Therefore, the time slot in which the signal light is not inserted is not generated in the time slots fed into the input ports #1 to #4. For example, a dummy optical packet signal (hereinafter also referred to as dummy signal) is inserted in a period (time slot) during which the optical packet signal is not sent.

The dummy signal is an optical packet signal that includes a data string indicating the dummy. For example, the dummy signal is a data string that is produced such that light intensity and a mark ratio of the dummy signal are equalized to those of the optical packet signal. Therefore, the average power of the optical packet signal and the average power of the dummy signal are exactly or substantially equalized to each other.

That is, the power levels of the components of light fed into the SOAs #1 to #4 are exactly or substantially kept constant. Accordingly, the input optical power level is accurately obtained even if the power levels of the components of light fed into the SOAs #1 to #4 are obtained as the monitoring value of the optical receiver 21 in a certain measurement period defined by the plural time slots (processing in operation 1001 of FIG. 9).

On the other hand, the SOAs #1 to #4 are turned on and off to transmit and interrupt the input signal light according to the switching control of the optical gate switch controller 234. The optical packet signals are selectively supplied from SOAs #1 to #4 by the switching control.

The outputs of the SOAs #1 to #4 are introduced to the merge coupler 13-1, and are merged by the merge coupler 13-1 and supplied to the output port #1. Similarly to the output port #1, for the output ports #2 to #4, the optical packet signals selectively supplied from the SOAs #1 to #4 are merged by and supplied from the corresponding merge couplers 13-2 to 13-4.

Part of the signal light supplied from each of the SOAs #1 to #4 is branched by the branch coupler 17 and fed into the optical receiver 22.

The optical packet signal that should be supplied (transmitted) is selectively supplied by the switching control of the optical gate switch controller 234 at the outputs of the SOAs #1 to #4, and the dummy signal is interrupted. Because a time the optical packet signal is supplied and a time the optical packet signal is not supplied exist at the outputs of the SOAs #1 to #4, the optical output power level is not obtained only by monitoring the output optical power.

Therefore, the optical output power level computer 231 monitors the average output optical power in a certain measurement period, for example in a period of 100 time slots based on the output of the optical receiver 22 (processing in operation 1001 of FIG. 9), and obtains information (switching control information) on the number of optical packet signals transmitted through the SOA #i in the measurement period from the optical gate switch controller 234.

The optical output power level computer 231 obtains the optical output power level in each SOA #i from the equation (2) based on the average output optical power in the measurement period and the switching control information (processing in operation 1002 of FIG. 9). The optical output power level computer 231 supplies the obtained optical output power level to the optical gain computer 232.

The optical gain computer 232 obtains the optical gains of the SOAs #1 to #4 based on the input optical power levels of the SOAs #1 to #4 and the optical output power levels of the SOAs #1 to #4 computed by the optical output power level computer 231 (processing in operation 1003 of FIG. 9). The optical gain computer 232 supplies the obtained optical gain to the redundancy switching determination unit 233.

The redundancy switching determination unit 233 compares the optical gains of the SOAs #1 to #4 obtained by the optical gain computer 232 with the predetermined threshold in periodic timing, and determines whether or not the deterioration amount of the optical gain falls within the allowable range (processing in operation 1004 of FIG. 9).

For example, when all the optical gains of the SOAs #1 to #4 obtained by the optical gain computer 232 exceed the predetermined threshold, the redundancy switching determination unit 233 determines that the deterioration amount of the optical gain falls within the allowable range, and continues the monitoring (YES in operation 1005 of FIG. 9).

On the other hand, when one of the optical gains of the SOAs #1 to #4 obtained by the optical gain computer 232 is equal to or smaller than the predetermined threshold (NO in operation 1005), the redundancy switching determination unit 233 determines that the deterioration amount of the optical gain is out of the allowable range, and notifies the optical gate switch controller 234 that the deterioration amount of the optical gain is out of the allowable range.

In response to the notification, the optical gate switch controller 234 switches the working SOAs #1 to #4 to the backup SOAs #1 to #4 (processing in operation 1006 of FIG. 9).

Thus, in the first embodiment, when the SOA 12 is used as the optical switching gate in the optical packet switch system, the optical gain of the SOA 12 is correctly monitored during the operation of the system. Accordingly, the deterioration of the gain characteristic of the SOA 12 is detected during the operation of the system.

When the generation of the deterioration of the gain characteristic is detected, the SOA 12 in which the deterioration of the gain characteristic is generated may be switched to the backup SOA 12 without interrupting the operation. Accordingly, the reliability of the system is improved.

In the first embodiment, the optical gain monitoring function is applied to the optical packet switch system that switches the path of the optical packet. The optical gain monitoring function may widely be applied to an optical switch that switches the path of the light signal. The second and third embodiments will be described by way of example.

### [3] Second Embodiment

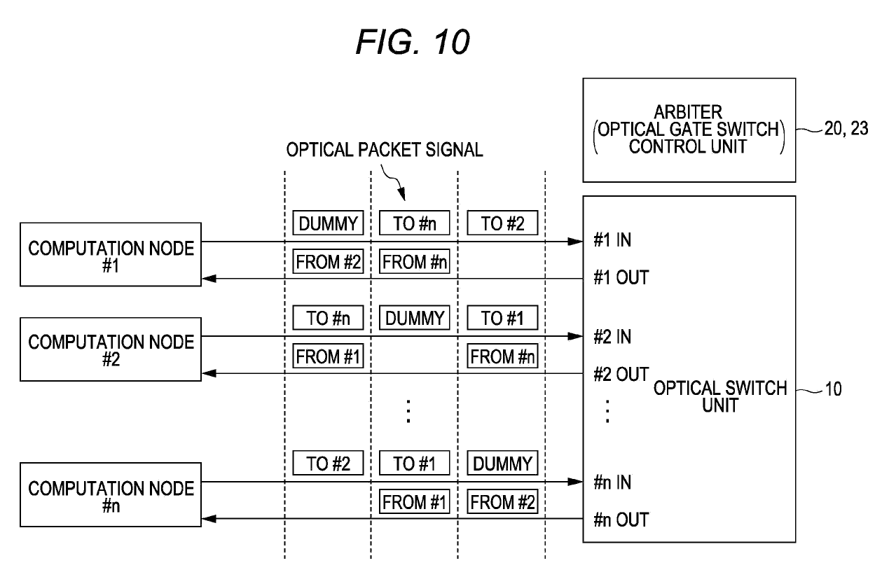

For example, the optical packet switch system of the first embodiment may be applied to an optical interconnect system used in a super computer. FIG. 10 illustrates an example of the optical interconnect system. Referring to FIG. 10, the n-by-n (n is an integer more than 1) optical switch unit 10 corresponds to the configuration in which the optical receivers 21 and 22 and the optical gain monitoring controller 23 are removed from the configuration of FIG. 7 of the first embodiment. A portion corresponding to the optical gain monitoring controller 23 is included in an arbiter 20.

Computation nodes #1 to #n (n is an integer more than 1) are connected to the optical switch unit 10. For example, the computation node #k (k=1 to n) is connected to input port #k and the output port #k of the optical switch unit 10. Therefore, the computation node #k conducts communication with any computation node.

The computation nodes #k make connection requests to the arbiter 20, and the arbiter 20 arbitrates (schedules) computation node #k that is permitted to be connected based on the connection request from the computation nodes #k. The arbiter 20 notifies the computation nodes #k of the schedule result (connection timing), and the optical gate switch controller 234 performs the switching control of the SOA 12 of the optical switch unit 10 based on the schedule result.

The computation nodes #k send the optical packet signals based on the schedule result of which the computation nodes #k are notified by the arbiter 20, and the dummy signal is inserted in the time slot in which the optical packet signal to be sent does not exist. Therefore, because the optical power level of the signal fed into the SOA 12 of the optical switch unit 10 is kept constant, the optical gain of the SOA 12 is accurately obtained like the first embodiment.

### [4] Third Embodiment

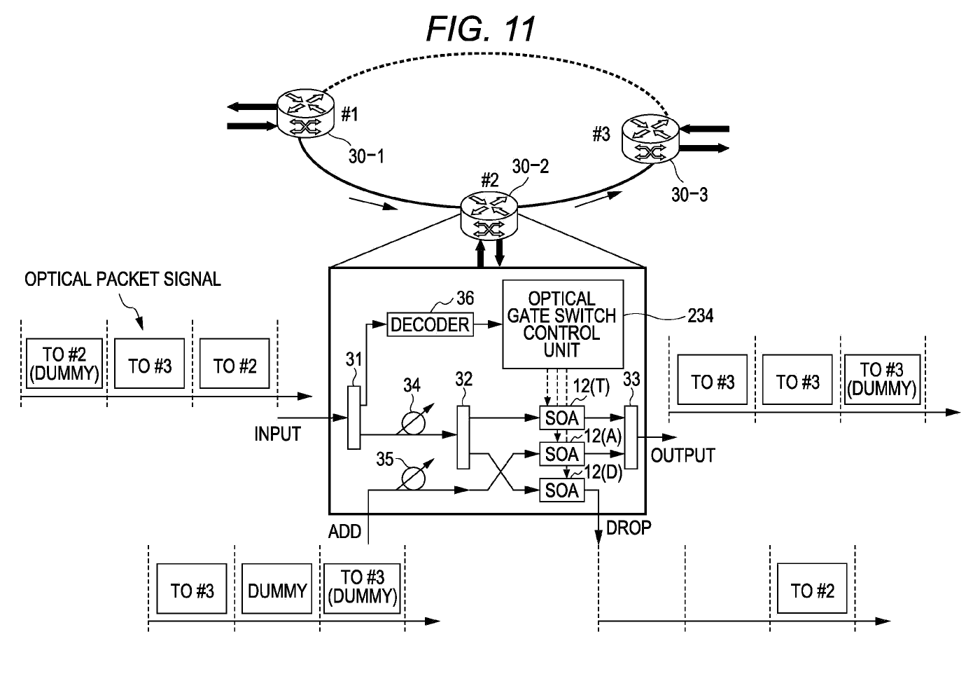

The optical gain monitoring function of the first embodiment is also applied to an Optical Add-Drop Multiplexer (OADM). FIG. 11 illustrates an example of the OADM. FIG. 11 illustrates a configuration that focuses on one OADM 30-2 in an optical network in which OADMs 30-1 to 30-N (N is an integer more than 1) that are examples of the plural optical transfer nodes are connected into a ring shape. FIG. 11 illustrates only three OADMs (#1 to #3) 30-1 to 30-3 (hereinafter referred to as OADM 30 when OADMs 30-1 to 30-3 are not distinguished from one another).

The OADM 30 that is an example of the optical switch unit has a drop function of dropping and receiving the optical packet signal, a through function of transmitting the signal light except for the dropped light, and an add function of adding the optical packet signal that should be sent to another optical transfer node 30 to the transmitted signal light.

Therefore, the OADM 30 includes SOAs 12 for the drop function, the through function, and the add function. In FIG. 11, SOA 12D for the drop function is used for the dropped light in the light fed into the input port, SOA 12T for the through function is used for the light transmitted from the input port to the output port, and SOA 12A for the add function is used for the light added to the output port. The SOAs 12T, 12A, and 12D act as the optical add/drop/through unit that is an example of the optical switch unit.

The OADM 30 includes, for example, optical couplers (1:2 branch couplers) 31 and 32, an optical coupler (2:1 merge coupler) 33, variable optical delay devices 34 and 35, a decoder 36, and the optical gate switch controller 234.

The branch coupler 31 is connected to an input port into which the signal light is fed from the OADM 30-1, and the branch coupler 31 branches the signal light into two components. One of the components of branched light is fed into the decoder 36, and the other piece of branched light is delayed by the variable optical delay device 34 and fed into the branch coupler 32.

The branch coupler 32 branches the input signal light into two components. The branch coupler 32 supplies one of the components of branched light to the SOA 12T for the through function, and supplies the other piece of branched light to the SOA 12D for the drop function.

The variable optical delay device 35 delays the added signal light and supplies the signal light to the SOA 12A for the add function.

Delay amounts of the variable optical delay devices 34 and 35 are determined (controlled) such that the optical packet signals (including dummy signal) are fed into the SOAs 12T, 12A, and 12D in switching (gating) timing of the optical gate switch controller 234. For example, the control is performed by the optical gate switch controller 234.

The SOA 12T is subject to the gating control of the optical gate switch controller 234, and selects the optical packet signal of the through target and supplies (transmits) the selected optical packet signal to the merge coupler 33.

The SOA 12A is subject to the gating control of the optical gate switch controller 234, and selects the optical packet signal of the add target and supplies (transmits) the selected optical packet signal to the merge coupler 33.

The SOA 12D is subject to the gating control of the optical gate switch controller 234, and selects the optical packet signal of the drop target and supplies the selected optical packet signal to the optical receiver.

The optical gate switch controller 234 performs the gating control to the SOAs 12T, 12A, and 12D based on information obtained by the decoder 36. The decoder 36 decodes header information included in the optical packet signal that is supplied from the input port through the branch coupler 31. The header information includes information indicating whether the optical packet signal given to the header information should be transmitted through the OADM 30 or dropped by the OADM 30.

The optical gate switch controller 234 controls timing of turn-on/off of the SOAs 12T, 12A, and 12D based on the information. The timing (time slot) in which the optical packet signal to be added is inserted may be determined by specifying the time slot of the optical packet signal of the drop target.

The merge coupler 33 merges the output of the SOA 12T for the through function and the output of the SOA 12A for the add function, and supplies the merged output to the output port to another optical transfer node (for example, OADM 30-3).

In the OADM 30, the add unit produces and inserts the dummy signal in order to keep the power levels of the components of light fed into the SOAs 12T, 12A, and 12D constant.

As illustrated in FIG. 11, it is assumed that the optical packet signal addressed to the OADM #2, the optical packet signal addressed to the optical transfer node #3, and the dummy signal inserted at the optical transfer node 30-1 and addressed to the OADM #2 are fed into the input port of the OADM #2 while inserted in each time-series time slot. Further, it is assumed that the optical packet signal is sent to the optical transfer node #3.

At this point, the optical packet signal addressed to the OADM #2 is transmitted through the SOA 12D and dropped by the optical receiver, and the optical packet signal addressed to the optical transfer node #3 is transmitted through the SOA 12T to the output port. The dummy signal addressed to the OADM #2 is not selected by the SOAs 12T, 12A, and 12D, and the dummy signal is interrupted.

That is, for the SOAs 12T and 12D, the input optical power level becomes constant through the three time slots. In order to keep the input optical power level constant through the three time slots for the SOA 12A, the add unit produces the dummy signals of the two time slots, the dummy signals are supplied to the SOA 12A while inserted in two time slots other than the time slot of the optical packet signal addressed to the optical transfer node #3. One of the two dummy signals is interrupted by the SOA 12A, and the other dummy signal is addressed to the optical transfer node #3.

The dummy signal addressed to the optical transfer node #3 is selected by the SOA 12A and supplied to the output port to the optical transfer node #3. Accordingly, the input optical power levels of the SOAs 12T, 12A, and 12D are kept constant in the optical transfer node #3. The same holds true for other optical transfer nodes.

Thus, the input optical power levels of the SOAs 12T, 12A, and 12D are kept constant in each OADM 30. The optical gain monitoring of the first embodiment is applied to the SOAs 12T, 12A, and 12D, which allows the optical gains of the SOAs 12T, 12A, and 12D to be correctly monitored.

In the embodiments, the optical gain of the SOA that is an example of the optical gate device is monitored by way of example. The monitoring technique may be applied to the monitoring of input and output characteristics of an optical device, such as an electro absorption optical gate device, which has the switching function.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical gate device which transmits or interrupts input light according to control information, comprising:
a light-receiver that obtains input and output optical powers of the optical gate device; and
a monitor that obtains optical input and output characteristics of the optical gate device based on the control information and the monitored input and output optical powers, the optical input and output characteristics being equivalent to a time the optical gate device is controlled in a transmitted state.

2. The optical gate device according to claim 1, wherein the monitor includes:
an optical output computer which computes an optical output power level of the optical gate device based on a ratio of the time the optical gate device is controlled in the transmitted state in a certain measurement period, the ratio being obtained based on the control information, and based on the output optical power of the optical gate device in the measurement period, the optical output power level being equivalent to the time; and
an optical input and output characteristic computer which computes the optical input and output characteristic based on the optical output power level computed by the optical output computer and an input optical power level of the optical gate device in the measurement period.

3. The optical gate device according to claim 1, comprising:
a working optical gate device;
a backup optical gate device; and
an optical gate device switching controller which switches the optical gate device from the working optical gate device to the backup optical gate device when the optical input and output characteristic obtained by the monitor deteriorates more than a predetermined threshold.

4. The optical gate device according to claim 2, wherein the input light is light in which a dummy light signal is inserted in a period, during which a light signal to be transmitted does not exist, such that an optical power level is kept constant in the measurement period.

5. The optical gate device according to claim 4, wherein the dummy light signal is a light signal having an optical power level and a mark ratio, the optical power level and the mark ratio being identical with those of the light signal.

6. An optical switch system which is the optical gate device according to claim 1, wherein the optical gate device is a semiconductor amplifier, and
the optical input and output characteristic is an optical gain characteristic of the semiconductor amplifier.

7. An optical switch system comprising:
an optical receiver which measures a power of input light;
an optical switch which includes a plurality of optical gate devices, the optical gate device transmitting or interrupting the input light;
a controller which controls a transmitted state or an interrupted state of the optical gate device; and
a monitor which obtains optical input and output characteristics of each optical gate device based on information on the control of each optical gate device and input and output optical powers of each optical gate device, the optical input and output characteristics being equivalent to a time the optical gate device is controlled in the transmitted state.

8. The optical switch system according to claim 7, wherein the optical switch is an n-by-n optical switch including n input ports; n output ports; and an n-by-n optical gate devices which supply light fed into one of the input ports to one of the output ports.

9. The optical switch system according to claim 8, where n is an integer greater than 1.

10. The optical switch system according to claim 7, wherein the optical switch unit is an optical add/drop/through unit including a transmission optical gate device which transmits light from an input port to an output port; an add optical gate device which is used for sending light added to the output port; and an optical gate device which is used for dropped receiving light in the light fed into the input port.

11. The optical switch system according to claim 7, wherein each of the optical gate devices is a semiconductor amplifier, and
the optical input and output characteristic is an optical gain characteristic of the semiconductor amplifier.

12. A method for an optical gate device which transmits or interrupts input light according to control information, the method comprising:
obtaining input and output optical powers of the optical gate device; and
obtaining optical input and output characteristics of the optical gate device based on the control information and the obtained input and output optical powers, the optical input and output characteristics being equivalent to a time the optical gate device is controlled in a transmitted state.
